(19) United States
(12) Patent Application Publication
(10) Pub. No.: US 2006/0028819 A1
(43) Pub. Date: Feb. 9, 2006

(54) Automotive lighting apparatus

(76) Inventors: Reggie B. Shankland, Wadsworth, OH (US); Roger L. Shankland, Norton, OH (US)

Correspondence Address: HAHN LOESER & PARKS, LLP, One GOJO Plaza, Suite 300, AKRON, OH, 44311-1076, US

(21) Appl. No.: 11/194,267

(22) Filed: Aug. 1, 2005

Related U.S. Application Data
(60) Provisional application No. 60/592,637, filed on Jul. 30, 2004.

(51) Int. Cl. F21V 33/00

(52) U.S. Cl. 362/253; 362/119

(57) ABSTRACT

A mobile illuminating tool tray includes upper and lower compartments and wheels attached to the tray for mobility purposes. The lower compartment includes a lighting fixture and bulb used to illuminate the upper compartment and the underside of a vehicle while the vehicle is being repaired. A floor member separates the lower compartment from the upper compartment, which is used to support tools during the repair process. The floor member is translucent and/or transparent to allow the light to shine upwardly during use thereby illuminating the upper tray compartment, repair tools and the underside of the vehicle.

This patent application claims priority to U.S. provisional patent application Ser. No. 60/592,637 filed Jul. 30, 2004, which is incorporated herein by reference in its entirety.

### FIELD OF THE INVENTION

This invention relates to light sources for work related environments and more specifically, to mechanic's assistants that provide underbody lighting and that are capable of supporting tools and parts as may be needed by the mechanic.

### BACKGROUND

The existence and use of mechanic's creepers and assistants is known in the art. The primary use of mechanic's creepers and assistants arises from working on a vehicle, such as an automobile or truck, especially as related to the underbody repair of a vehicle, although creepers and assistants find other uses in homes and commercial buildings, such as, for example, the repair of certain types of machinery. Due to the nature of underbody repair, artificial lighting is typically required. While the mechanic uses a creeper to support himself/herself in a horizontal position under the work piece, certain devices exist that include a light source for illuminating the work area on the underside of the work piece.

One aspect of these illuminating devices relates to the limited amount of lighting available and the interference of the available light with respect to the mechanic. In response to these situations, various mechanic's assistants have arisen. Still, problems remain with the existing prior art for mechanic's assistants. For example, the prior art lacks the ability to provide adequate lighting for illuminating the entire underside work area while maintaining necessary tool and parts storage capacity. Moreover, the prior art does not directly illuminate or highlight all the various tools being employed in the work area so that when each tool is needed it can be readily accessed.

### BRIEF SUMMARY

The improvements in lighting output and distribution, and the effectiveness and efficiency of storage design, and other aspects of the present invention are directed to an apparatus that satisfies diverse lighting needs, including vehicle underbody service needs, in residential and commercial applications. In one embodiment, the apparatus comprises a wheeled structure with an enclosed directed light source where the apparatus is suitable and convenient for resting and storing tools, and where the apparatus' upper surface is sturdy enough to withstand dropped tools, as described in detail below.

The automotive lighting apparatus may be an illuminating tool holding device that includes a generally shallow open top housing having one or more side walls and a bottom section. The side walls and the bottom section define a cavity, wherein the side walls include a recess fashioned around the perimeter of the top of the one or more side walls. The illuminating tool holding device may also comprise a tool tray having shallow sides, a light permeable base section and a lip projecting outwardly from the shallow sides. The lip extends around the perimeter of the tool tray for use in being mounted to the recess. The base section spans the area between the side walls at a midpoint of the side walls segmenting the cavity into an upper open top tray and a lower enclosed compartment. The illuminating tool holding device may further comprise a gasket disposed around the recess. The gasket is pliable to create a seal between the housing and the tool tray. Also included in the device is an electrical light bulb receptacle, one or more light bulbs operatively connected to the electrical light bulb receptacle, a current carrying power cord having a electrical plug at one end of the electrical power cord, wherein the current carrying power cord operatively connects to the electrical light bulb receptacle, and a power switch electrically communicated between the electrical light bulb receptacle and the plug of the current carrying power cord. The power switch is mounted to an upper surface of the housing so as to allow the user to turn on the device with a hand or foot. An electrical outlet may be mounted to an exterior surface of the housing and is electrically communicated to the power cord to provide power to accessories such as a power drill.

One aspect of the present invention includes a handle extending from a first end of the housing and a plurality of caster wheels operatively connected to the housing for use in providing mobility to the illuminating tool holding device.

Another aspect of the present invention includes an automotive lighting apparatus having an overall height that is substantially in the range of about 1 to 6 inches, but may be between 1 and 10 inches.

Another aspect of the present invention includes a seal mounted between a light permeable tool tray and the recess fashioned in a top edge of the one or more side walls of the housing for use in preventing material from passing into a lower enclosed compartment.

Yet another aspect of the present invention includes one or more of the ground engaging wheels that are caster wheels.

Still another aspect of the present invention includes a support stand pivotally connected to the housing at one end of the housing.

Another aspect of the present invention includes a battery mounted within the lower enclosed compartment of the housing that is electrically communicated to a power cord.

Yet another aspect of the present invention includes one or more fluorescent light bulbs operatively connected to the lighting fixture and a ballast operatively connected between the power cord and the lighting fixture.

Another aspect of the present invention includes a selectively removable tool tray insert that includes an insert base portion constructed from a light permeable material. Tool shaped recesses are fashioned in the body of the insert.

### BRIEF DESCRIPTION OF THE DRAWINGS

FIG. 1 is a perspective view of the automotive lighting apparatus, in accordance with an embodiment of present invention.

FIG. 2 is a perspective view of the housing and lighting source of the automotive lighting apparatus, in accordance with an embodiment of present invention.

FIG. 3 is a perspective view of the lens and gasket of the automotive lighting apparatus, in accordance with an embodiment of present invention.

FIG. 4 is a perspective view of the insert of the automotive lighting apparatus, in accordance with an embodiment of present invention.

FIG. 5 is a side view of the automotive lighting apparatus, in accordance with an embodiment of present invention, showing the caster wheels.

FIG. 6 is a perspective view of the automotive lighting apparatus tilted upward showing the support stand, in accordance with an embodiment of present invention, showing the caster wheels.

### DETAILED DESCRIPTION

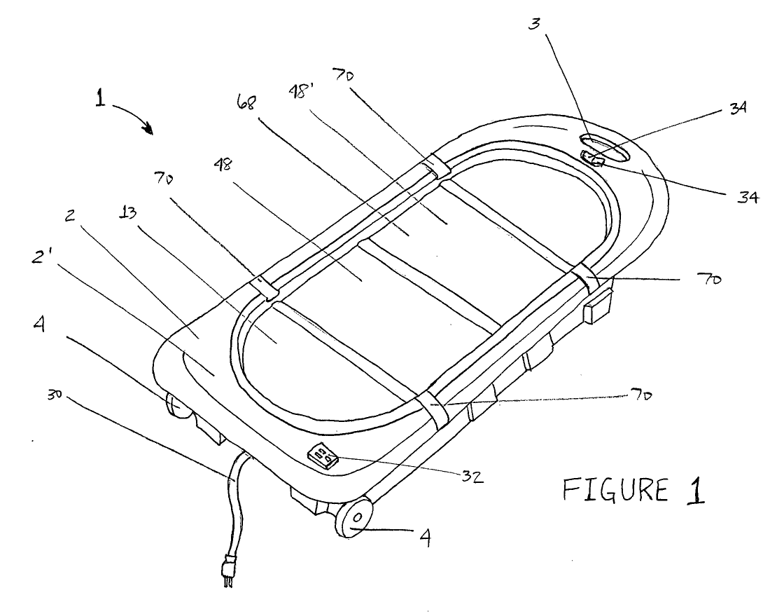

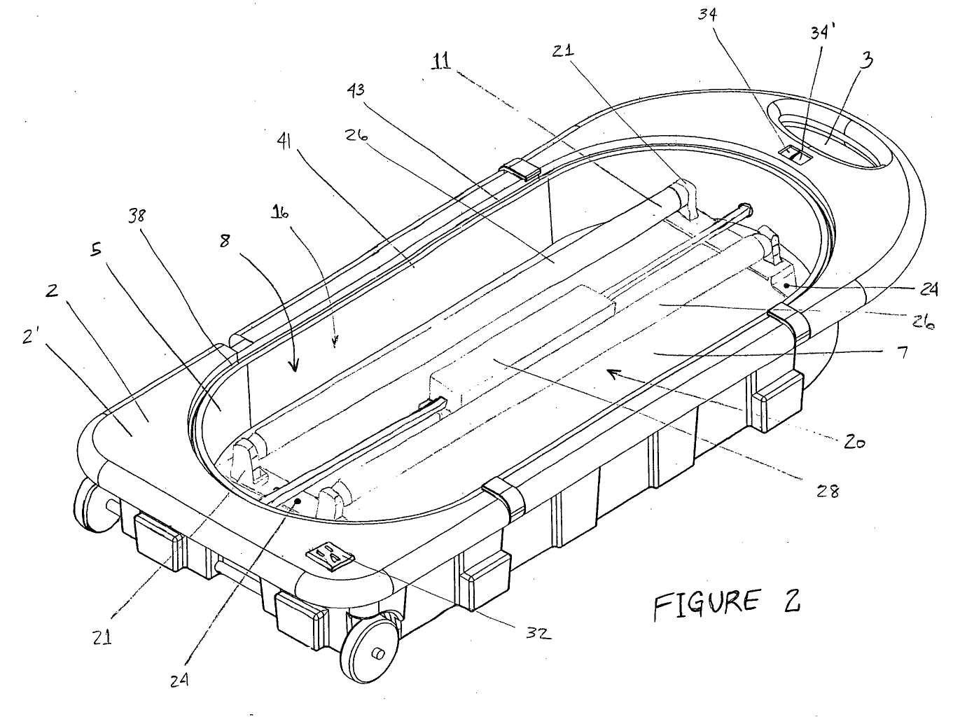

Referring now to the drawings wherein the showings are for purposes of illustrating embodiments of the invention only and not for purposes of limiting the same, FIG. 1 shows an automotive lighting apparatus depicted generally at 1. The automotive lighting apparatus 1 consists of a shallow, low to the ground structure that provides both lighting to the underside of a vehicle and provides a place to hold tools used to work while under the vehicle. Thus, the automotive lighting apparatus 1 is sized to maneuver under objects having low clearance. While the present embodiment discusses the use of the automotive lighting apparatus 1 under a vehicle, like a car or truck, it is to be construed that the present invention may be used on any device or structure having a low clearance that requires illumination and/or maintenance. Accordingly, the automotive lighting apparatus 1 may include a generally shallow box-like structure or housing 2 that functions to support the components of the automotive lighting apparatus 1. The housing 2 may include walls 5 and a bottom section 7 that are contiguously formed to define an open top cavity 8 as shown in FIG. 2. A lighting source 11 may be mounted within the cavity 8 for use in providing light to illuminate the intended objects. As the bottom of the housing is enclosed light emanating from the lighting source 11 is reflected outward through the open top. A break resistant lens 13 may be included that fits within the cavity 8. The lens 13 may be transparent or translucent, which allows light to pass through the lens 13 thereby illuminating the intended objects.

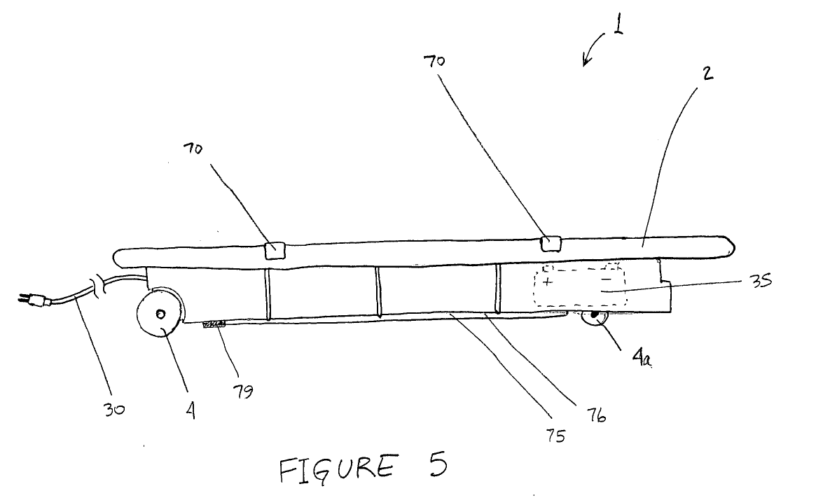

With reference to FIG. 1 and now also to FIG. 2, the housing 2 comprises a box-like structure 2′ having an opening 16 in its top surface. The opening 16 may encompass a majority of the top surface or any portion thereof. The housing 2 may include one or more sidewalls 5 and a bottom section 7. The sidewalls 5 may be shallow or short in height to allow to the automotive lighting apparatus 1 to slide under low clearance objects such as a vehicle. In one embodiment, the sidewalls 5 may be five inches in height in anotner embodiment it is contemplated that the height of the sidewalls 5 may be in the range of one to ten inches. However, any height of the sidewalls 5 may be chosen so as to allow for maneuverability under low clearance objects. In this manner the sidewalls 5 and more specifically automotive lighting apparatus 1 may be generally shallow. The housing 2 may be constructed from a polymer material, such as plastic. However, any process and material may be used to construct the housing 2 and the automotive lighting apparatus 1 as chosen with sound engineering judgment including but sheet metal, steel, and the like. The housing 2 may be a single contiguously formed article of which such processes are known in the plastic thermoforming industry. The housing 2 may also be formed from joining or connecting individual parts as is appropriate for the subject invention. As shown in the FIGURES, the housing 2 is depicted to be generally elongate with a rectangular or oval shape. However, any configuration or shape of the housing may be chosen including but not limited to: circular, diamond or triangular shapes. The housing 2 may also include a handle 3 portion fashioned as an aperture in the housing body making it easy to carry the automotive lighting apparatus 1 from place to place. Finally, ground-engaging wheels 4 may be rotatably connected to the housing 2 for use in providing mobility to maneuver the automotive lighting apparatus 1 on the ground. Two wheels 4 may be positioned at a first end of the housing 2. An additional, a third wheel 4a, shown in FIG. 5, may be included that is rotatably connected to the housing 2 at a distal end near the handle aperture 3. While in one embodiment the third wheel 4a may be a caster wheel, any of the wheels 4 may be of the caster wheel type.

With continued reference to FIGS. 1 and 2, a light source, shown generally at 20, may be included within the automotive lighting apparatus 1. The light source 20 may include a lighting fixture 21 mounted within the cavity 8 of the housing 2. Fasteners 24 or other securing means may be used to hold the lighting fixture 21 in place. In one embodiment, the lighting fixture 21 may be a fluorescent bulb lighting fixture 21. Accordingly, the automotive lighting apparatus 1 may include fluorescent bulbs 26. Two fluorescent bulbs 26 are shown in the FIGURES, although any number of bulbs 26 may be chosen as is appropriate for use with the subject invention. The light source 20 may further include a ballast 28 to create the requisite voltage needed to operate the fluorescent bulbs 26. A power cord 30 may be installed and electrically connected to deliver electrical power from an associated power source, such as a typical electrical wall outlet. While the current embodiment, describes fluorescent bulbs and components, it is to be construed that alternate types of lighting sources may be incorporated into the automotive lighting apparatus 1. Such devices may include incandescent lighting, LED lighting, neon lighting and the like. Any type of illuminating device may be incorporated without departing from the intended purposes of the subject invention. A switch 34 may also be incorporated into the light source circuit between the power cord 30 and the lighting fixture 21 to enable the user to selectively operate the light source 20. To make it easier to turn the automotive lighting apparatus 1 on and off during use, the switch 34 may be mounted to an upper surface of the housing 2, although the switch may be positioned at any place on the automotive lighting apparatus 1. Additionally, an accessory outlet or power outlet 32 may be electrically connected to the light source circuit. The outlet 32 may receive a standard electrical plug as might be found on a power drill cord or other electrically operated device. Conductors from the power cord 30, connected in parallel with the lighting fixture, may be communicated to the outlet 32 extending the range of the electrically operated device. For convenience, the outlet 32 may be mounted to an exterior upper surface of the housing 2.

With reference again to FIGS. 1 and 2 and now to FIG. 5, it is contemplated in an alternate embodiment, that electrical power may be supplied to the light source 20 via an on-board battery 35. The battery 35 may include conductors, not shown, that electrically connect to the lighting fixture 21 for use in supplying power to the bulbs 11. The battery 35 may be used in conjunction with the power cord 30. That is to say that the battery 35 may be electrical communicated to the power cord 30 and to the lighting fixture 21. In this way, the power cord 30 may supply electrical power from an associated power source to operate the light source 20 and/or to charge the battery 35 as needed. A three-position switch 34′ may be incorporated that allows the operator to select power from the either the battery 35 or the power cord 30 as desired. Alternatively, an electrical switching control device, not shown, may be included that automatically switches between the battery power and the power from the power cord 30 responsive to a threshold voltage or current level of the battery 35. Still, any manner of supplying and switching power to operate the light source 20 may be chosen with sound engineering judgment.

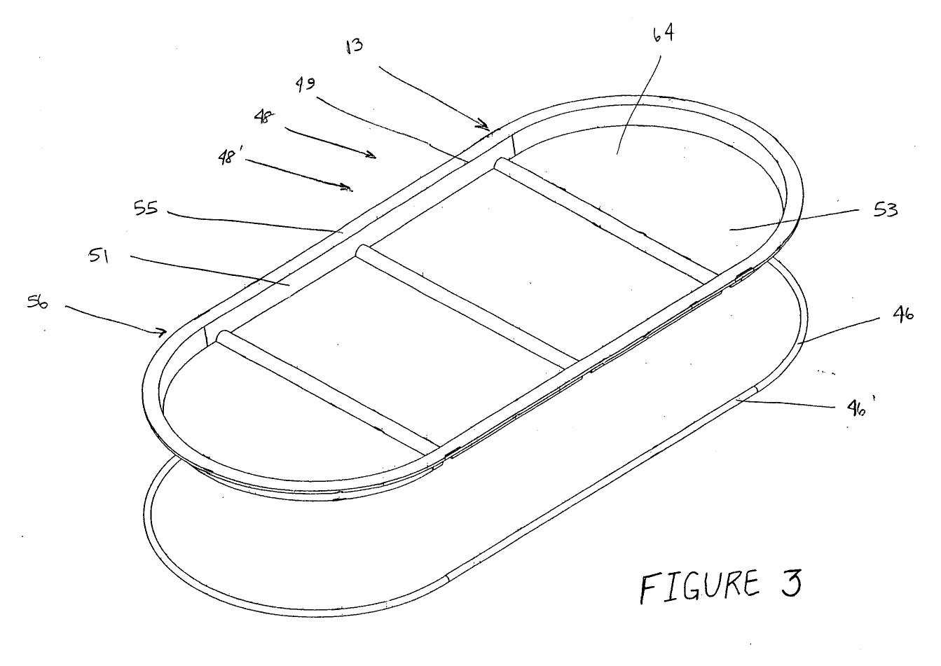

With reference now to FIGS. 1 through 3, the housing 2 may include a recess 38 fashioned within the housing 2 and around the perimeter of an upper edge 41 of the cavity 8. In one embodiment, the recess 38 may extend in a continuous unbroken manner about the entire periphery of the upper edge 41. The recess 38 may comprise a generally U-shaped channel 43 or alternatively an angled flat ledge, not shown, for holding a seal 46 in place as will discussed further below. It is noted at this point that any configuration of recess 38 may be fashioned in the housing 2 as is appropriate for use in creating a sealed barrier against contamination. It is further noted that any cross-sectional configuration of cavity 8 may be chosen as is appropriate for use with the subject invention. As one of the intended uses of automotive lighting apparatus 1 is to assist the user while working under a vehicle, the automotive lighting apparatus 1 may allow for the placement of tools and parts on top the device 2 while retaining the required clearance for use under the work piece. Accordingly, a rigid panel 48 may be connected to the housing 2 to hold the tools used by an operator during repair and/or maintenance of a vehicle. The panel 48 may extend completely across the open cavity 8 of the housing 2. In one embodiment, the panel 48 may be a tool tray 48′ having walls 51, a base section 53 and a lip 55 protruding laterally from the walls 51 and fashioned about the peripheral edge 49 of the tool tray 48′. The tool tray 48′ may be attached to the housing 2 by laying the lip 55 on top of the recess 38. It will be appreciated by a person skilled in the construction of such devices that the dimensions of the panel 48 and/or tool tray 48′ may be appropriately sized to correspond to the dimensions and configuration of the recess 38. It follows then that as the seal 46 may first be inserted into the recess 38, the underside 56 of the lip 55, when placed against the recess 38, creates a barrier that prevents unwanted material from entering into the cavity 8. Accordingly, the seal 46 may be a gasket 46′ made from a resiliently deformable or pliable material. Thus in the specific configuration where the panel 48 is a tool tray 48′, the walls 51, which rigidly extend between the lip 55 and the base section 53, position the base section 53 downward in the cavity 8 at a midpoint thereof. Of course, any configuration of panel 48, seal 46 and recess 38 may be chosen with sound engineering judgment as is appropriate for use in sealing unwanted material from entering the cavity 8. In this way, the panel 48 spans a midpoint of the walls 5 of the cavity 8 thereby separating the cavity 8 into a lower enclosed compartment and an upper open-top tray.

With continued reference to FIGS. 1 through 3, the panel 48 may function as a see-through lens 13 allowing light emanating from the light source 20 and reflected by the interior cavity 8 of the housing 2 to be directed outward to illuminate the desired area. The panel 48 may be transparent as initially described, although the panel may also be translucent allowing light to penetrate the base section 53 while shrouding the components enclosed in the lower compartment. However, any light permeable material may be used to construct the panel 48 and/or the base section 53 including but not limited to plastic, vinyls or polyvinyls, tempered glass and laminated glass composites. The panel 48 may also be break resistant and/or scratch resistant as tools are placed onto and taken from the panel surface 64.

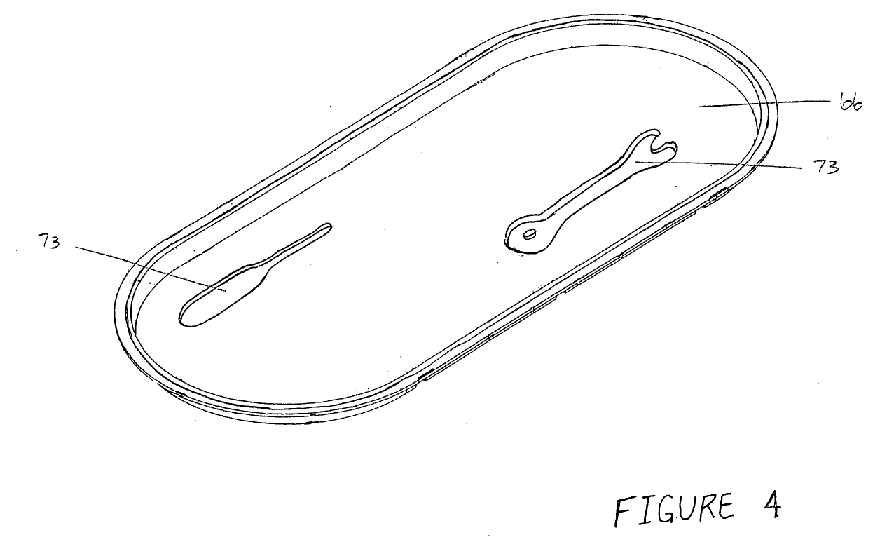

With continued reference to FIGS. 1 through 3 and now especially to FIG. 4, the automotive lighting apparatus 1 may include an insert 66 that has a similar shape and dimension to the upper open-top tray area 68 formed by the panel 48. The inserts 66 may fit into the open-top tray area 68 thereby protecting the panel 48 from damage during use. Clips 70 may be included that hold the panel 48 and/or insert 66 in place during use. The clips 70 may be pivotally connected to the housing at one end and snapped into fastening engagement with the housing 2. However, it is noted that any type and quantities of fasteners may be used to hold the panel 48 and/or insert 66 in place during use. In one embodiment, the insert 66 may include prefabricated slots or tool-shaped recesses 73 fashioned in the insert 66 for holding associated tools in place when not in use.

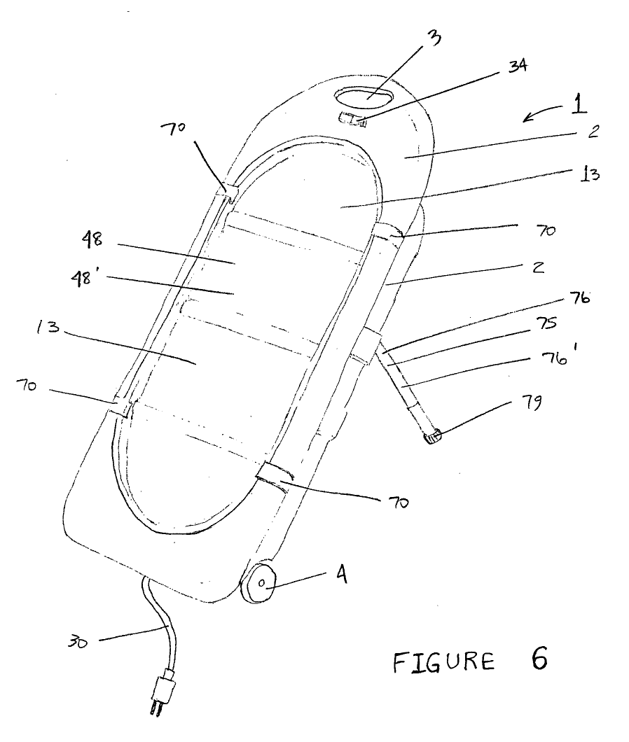

With reference now to FIG. 6, the automotive lighting apparatus 1 may include a support stand 75 mounted to the underside of the housing 2. The support stand 75 may be a rigid rod 76 pivotally connected to the housing at a first end and selectively held in place against the underside of the housing by a latch, not shown. A rubber boot 79 may be inserted over the distal end 77 of the rod 76. In this manner, when the automotive lighting apparatus 1 is tilted upward and the latch (not shown) is removed, the rod 76 may be swung out away from the housing 2 to support the automotive lighting apparatus 1 in an upright position. In one embodiment, the support stand 75 may include a telescoping rod 76′ for adjusting the angle at which the automotive lighting apparatus 1 may be tilted. It is further contemplated in an alternate embodiment, that a different form of support stand 75 be incorporated into the subject invention that includes a scissor-action-type, height adjustable support stand that can adjust the overall height of the automotive lighting apparatus 1. However, any type of support stand may be included as is appropriate for use with the subject invention.

The invention has been described herein with reference to the preferred embodiment. Obviously, modifications and alterations will occur to others upon a reading and understanding of this specification. It is intended to include all such modifications and alternations in so far as they come within the scope of the appended claims or the equivalence thereof.

What is claimed is:

1. An illuminating tool holding device, comprising:
a generally shallow open top housing having one or more side walls and a bottom section, the one or more side walls and the bottom section defining a cavity, wherein the one or more side walls include a recess fashioned around the perimeter of the top of the one or more side walls;
a tool tray, the tool tray having shallow sides, a light permeable base section and a lip projecting outwardly from the shallow sides, the lip extending around the perimeter of the tool tray for use in being mounted to the recess, the base section of the tool tray spanning the area between the one or more side walls at a midpoint of the one or more side walls, the base section of the tool tray segmenting the cavity into an upper open top tray and a lower enclosed compartment;
a gasket juxtaposed between the recess and the lip, the gasket being pliable to create a seal between the recess and the lip;
an electrical light bulb receptacle;
one or more light bulbs operatively connected to the electrical light bulb receptacle;
a current carrying power cord having an electrical plug at one end of the electrical power cord, the current carrying power cord operatively connected to the electrical light bulb receptacle;
a power switch electrically communicated between the electrical light bulb receptacle and the electrical plug of the current carrying power cord, the power switch being operatively mounted to an upper surface of the housing;
an electrical outlet operatively mounted to an exterior surface of the housing, the electrical outlet being electrically communicated to the power cord;
a handle extending from a first end of the housing;
a plurality of caster wheels operatively connected to the housing for use in providing mobility to the illuminating tool holding device; and,
wherein the overall height of the illuminating tool holding device is substantially in the range of 1 to 6 inches.

2. An illuminating tool holding device, comprising:
an generally shallow open top housing having one or more side walls and a bottom section, the one or more side walls and the bottom section defining a cavity;
at least a first ground engaging wheel rotatably connected to the housing;
a light permeable panel operatively connected to the one or more side walls, the light permeable panel spanning the area between the one or more side walls at a midpoint of the one or more side walls, the light permeable panel segmenting the cavity into an upper open top tray and a lower enclosed compartment;
a lighting fixture received within the lower enclosed compartment, the lighting fixture being fixedly connected to the housing; and,
a current-carrying power cord operatively electrically connected to the lighting fixture.

3. The illuminating tool holding device of claim 2, wherein the one or more side walls includes a recess fashioned in a top edge of the one or more side walls, and,
wherein the light permeable panel is a light permeable tool tray having a lip fashioned at least partially about the perimeter of the light permeable tool tray, the lip being operatively received within the recess.

4. The illuminating tool holding device of claim 3, further comprising:
a handle fashioned in a first end of the housing.

5. The illuminating tool holding device of claim 4, further comprising:
a seal mounted between the light permeable tool tray and the recess fashioned in a top edge of the one or more side walls for use in preventing material from passing into the lower enclosed compartment.

6. The illuminating tool holding device of claim 5, wherein the at least a first ground engaging wheel, comprises:
at least first and second ground engaging wheels rotatably connected to the housing at a first end of the housing; and,
at least a third ground engaging wheel rotatably connected to the housing at a second end of the housing; and,
wherein one or more of the ground engaging wheels is a caster wheel.

7. The illuminating tool holding device of claim 6, further comprising:
a support stand pivotally connected to the housing at the second end of the housing.

8. The illuminating tool holding device of claim 7, further comprising:
an electrical outlet operatively mounted to the housing, the electrical outlet being electrically communicated to the power cord.

9. The illuminating tool holding device of claim 8, wherein the current-carrying power cord includes an electrical plug for use in connecting to an associated electrical power supply.

10. The illuminating tool holding device of claim 8, further comprising:
a battery mounted within the lower enclosed compartment, the battery being electrically communicated to the power cord.

11. The illuminating tool holding device of claim 9, further comprising:
one or more fluorescent light bulbs operatively connected to the lighting fixture; and, a ballast operatively connected between the power cord and the lighting fixture.

12. The illuminating tool holding device of claim 11, further comprising:
a selectively removable tool tray insert, the tool tray insert having an insert base portion, the insert base portion being constructed from a light permeable material.

13. The illuminating tool holding device of claim 12, wherein the tool tray insert has one or more tool shaped recesses fashioned in the base portion of the tool tray insert.
